(19) United States
(12) Patent Application Publication
(10) Pub. No.: US 2005/0095097 A1
(43) Pub. Date: May 5, 2005

(54) Receptacle lifter with retractable gripper arms

(76) Inventors: Ramiro Arrez, Orland Park, IL (US); James R. Rimsa, Countryside, IL (US); Carlos Arrez, Berwin, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/691,989

(22) Filed: Oct. 23, 2003

(51) Int. Cl. B65F 3/02

(52) U.S. Cl. 414/406

(57) ABSTRACT

A lifter assembly is disclosed that includes a carriage comprising a frame structure that is pivotally mounted to the lifter. First and second rigid gripper arms are pivotally mounted to the frame structure so as to be generally in alignment and in spaced relation. A third gripper arm is pivotally mounted to the frame structure, and the first, second and third gripper arms are moveable between a first position in which the first and second gripper arms are spaced apart from third gripper for receiving the refuse receptacle, and the second position in which the first, second and third gripper arms lay generally flat against the frame structure for storage with the third gripper arm nesting between the first and second gripper arms. In a second embodiment, two opposed rigid gripper arms are pivotally mounted to the frame structure and the first gripper arm is shaped so that, when in the second position, the second gripper arm nests in the first gripper arm.

### BACKGROUND OF THE INVENTION

The present invention relates to a container lifter for use with refuse collection vehicles and, more particularly, to an improved refuse receptacle lifter adapted for use with rear and side loading refuse collection trucks and containers.

Residential refuse is prepared for collection by the homeowner in many different ways. Depending upon local requirements, or the lack thereof, refuse may be left curbside and anything ranging from plastic garbage bags, to drums of various capacities, to plastic or galvanized-steel garbage cans, to highly engineered refuse receptacles designed to be secured to and lifted by specifically compatible lifters.

As is known, receptacle lifters have been provided that invert receptacle to dump its contents into a central collection bin in the collection vehicle. See, e.g., U.S. Pat. Nos. 6,503,045, 5,257,877, 5,069,593, 5,024,573, 4,911,600, and 4,741,658, all having a common assignee as the present application in which are incorporated by reference herein.

Because of expense, it is impractical to have a different collection vehicle with a lifter for each specific different type of residential container that may be used on different collection routes. In particular, container lifters associated with the collection vehicle are preferably capable of dumping a variety of differently-configured refuse receptacles, as well as having a storage position that does not interfere with the collection of bulk garbage from a large, wheeled refuse container used by multi-family dwellings and commercial establishments, or bags.

One style of lifters that has been used to pick-up containers of different shape employs extending arms to grasp or grab the container. One common issue with this type of lifter, however, is that the extending grab arms are vulnerable to damage as the vehicle is moved between pick-up locations. One version of such a lifter rotates the grab arms to a fully open position, where they extend in substantially opposite directions, to reduce the profile of the lifter. In this position, however, the arms occupy a substantial amount of space on both sides of the lifter. Thus, there continues to be a need for new and different refuse collection lifters that are suitable for lifting a variety of containers.

Accordingly, it is an object of the present invention to provide an improved refuse receptacle lifter adapted for use with rear loading and side loading refuse collection trucks.

More specifically, it is an object of the present invention to provide an improved receptacle lifter that is capable of gripping, lifting and dumping a wide variety of styles and sizes of residential refuse receptacles.

It is an additional object to provide an improved receptacle lifter that can be stored out of the way when not being used.

### SUMMARY OF THE INVENTION

These objects, as well as others that will become apparent upon reference to the following Detailed Description and accompanying drawings, are met by a lifter assembly that includes a carriage comprising a frame structure that is mounted to the lifter. In a first embodiment, two opposed rigid gripper arms are pivotally mounted to the frame structure. The gripper arms are moveable between a first position in which the first and second gripper arms are spaced apart for receiving the refuse receptacle, and the second position in which the first and second gripper arms lay generally flat against the frame structure for storage. An actuator is secured to the frame structure for moving the gripper arms between the first and second positions. The first gripper arm is shaped so that, when in the second position, the second gripper arm nests in a space defined by the first gripper arm.

In a second embodiment, the first gripper arm comprises two spaced-apart members that are pivotally mounted to the frame structure so as to be generally in alignment and in spaced relation so that when in the stowed position, the second gripper arm nests in the space between the two members of the first gripper arm.

### BRIEF DESCRIPTION OF THE FIGURE OF THE DRAWINGS

FIG. 1 is a fragmentary perspective view of a rear-loading refuse collection truck including a refuse receptacle lifter in accordance with one embodiment of the present invention mounted thereto.

FIG. 2 is a perspective view of a first embodiment of a refuse receptacle lifter according to the present invention, the lifter being adapted to be secured to a refuse collection vehicle, with the receptacle gripper arms in the open position for receiving a receptacle.

FIG. 3 is a perspective view similar to FIG. 2, except that the gripper arms are in the closed or stowed position.

FIG. 4 is a view of the lifter of FIG. 3 with the gripper arms in the stowed position taken from the reverse perspective to that of FIG. 3.

FIG. 5 is a perspective view of the lifter of FIG. 2 with the grasper in its raised inverted, dumping position.

FIG. 6 is a side view of the lifter shown in FIG. 3.

FIG. 7 is a top view of the gripper arms, and the actuation mechanism therefore, that are used in the lifter of FIG. 2, showing the gripper arms in the stowed position.

FIG. 8 is a perspective view of the lifter arms and actuator mechanism of FIG. 7 with the lifter arms in their open, receptacle receiving position.

FIG. 9 is a perspective view of a second embodiment of a refuse receptacle lifter according to the present invention, with the receptacle gripper arms in the receptacle receiving position to receive a receptacle.

FIG. 10 is a perspective view similar to FIG. 9, but with the gripper arms are in the closed or stowed position.

FIG. 11 is a perspective view of the lifter of FIG. 9 with the in its raised inverted, dumping position.

### DETAILED DESCRIPTION OF THE PREFERRED EMBODIMENTS

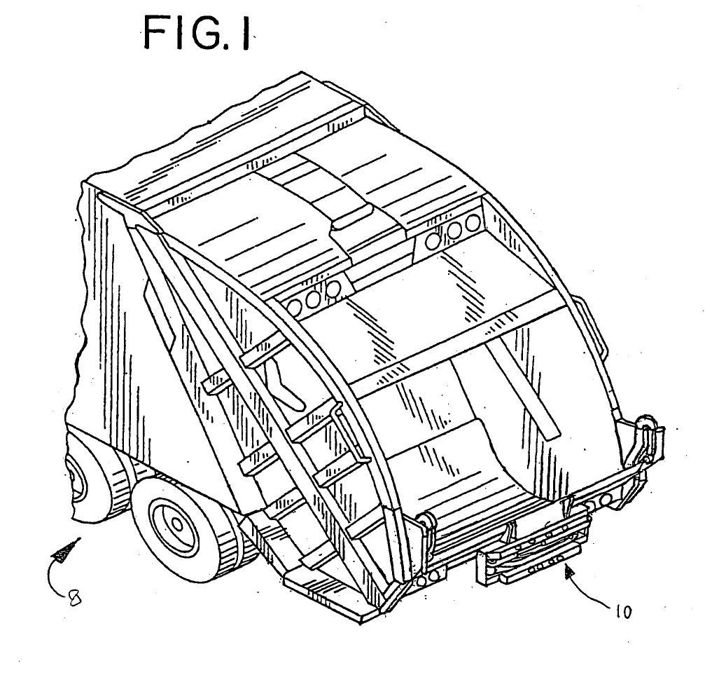

Turning to the figures of the drawings, there is seen in FIG. 1 a rear perspective view of a rear loading refuse collection truck 8 having a receptacle lifter assembly 10 mounted thereto. The lifter assembly 10 may be mounted to the hopper lip or sill of the refuse collection truck 8, the sill defining the lower extent of the opening in the hopper into which refuse is dumped. The lifter 10 may be mounted either singly or in tandem to the hopper sill and is designed to have a low profile when in the stowed position, so as to not to interfere with the operation of a tipper bar or cable and winch system, both typically used for dumping large, multi-cubic yard containers having trunnion bars on their front edges. The lifter 10 may also be used on side-load trucks, mounted to larger, multi-yard containers, or mounted to stationary refuse dumping stations without departing from the present invention.

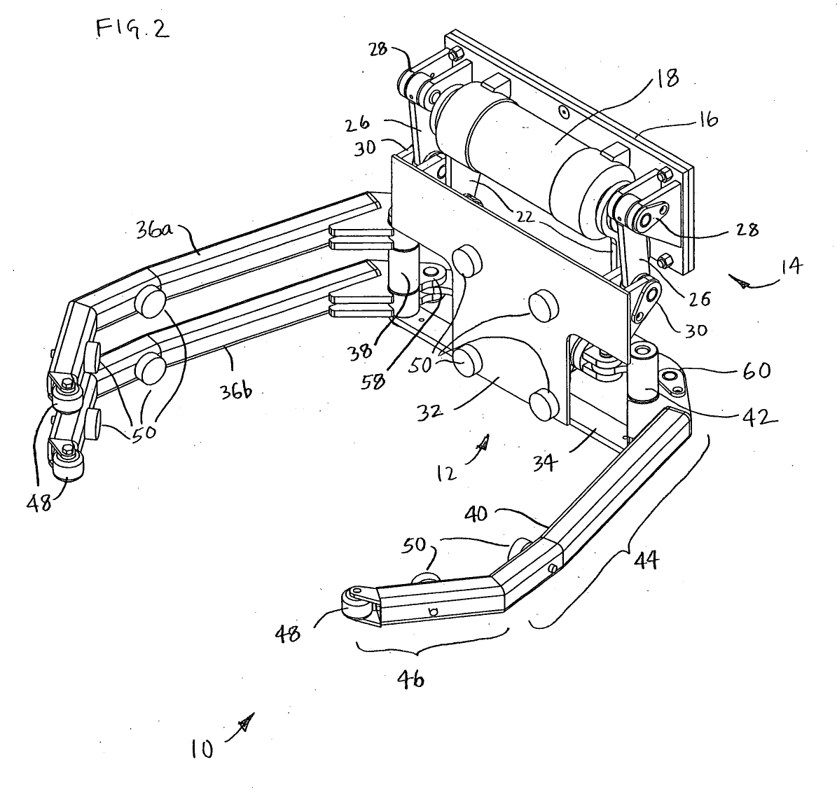

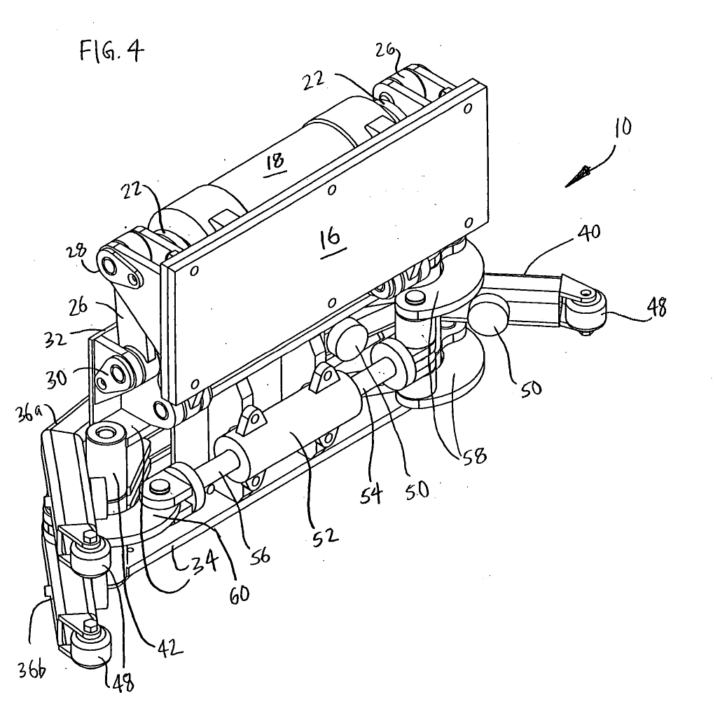

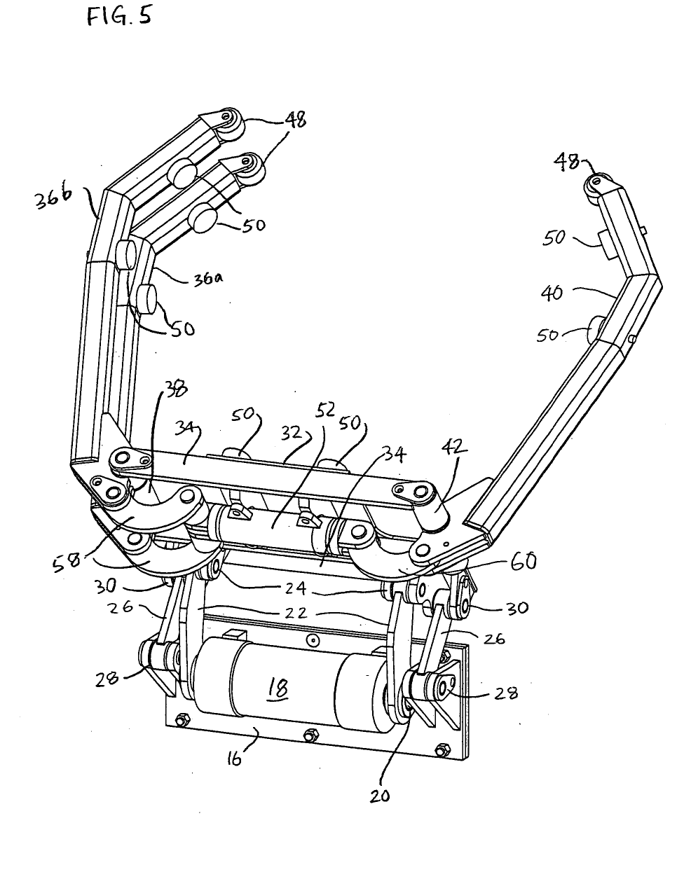

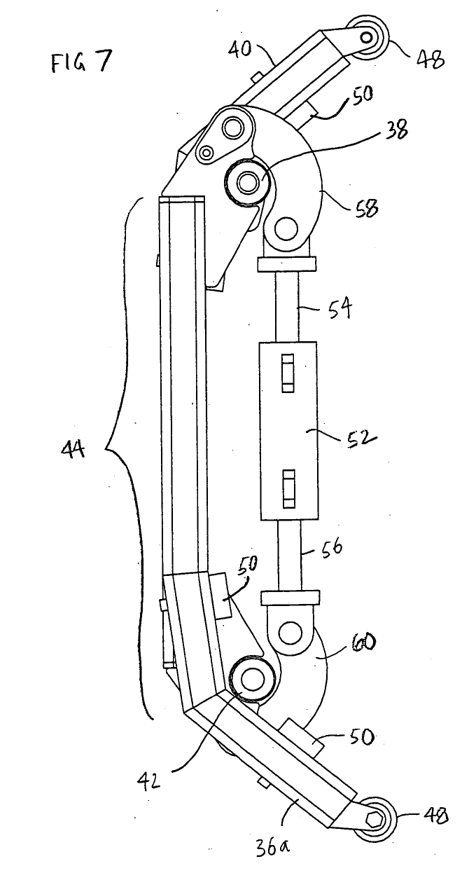

With reference to FIGS. 2-8, there is seen a first embodiment of a receptacle lifter assembly according to the present invention. The lifter assembly 10 comprises a grasper 12 for gripping and securing a refuse receptacle and a lifter mechanism 14 for raising and inverting a refuse receptacle—to dump its contents into the vehicle hopper—and for returning the receptacle to its upright position, where it is released from the grasper.

The lifter mechanism 14 may take many different forms. In the illustrated embodiment, the lifter mechanism 14 includes a base plate 16 by which the lifter assembly 10 is secured to the collection vehicle. A rotary hydraulic motor 18 is secured, as by welding or bolting, to the base plate 16 so that its actuator shaft 20 is disposed generally horizontally as well as generally parallel to the hopper sill. The motor 18 may be of any suitable design, and preferably is a helical hydraulic shaft rotary actuator as supplied by Helac Corporation of Enumclaw, Wash.

For lifting the carriage 12, one end of each of a pair of lift arms 22 is fixed to the opposite ends of the actuator shaft 20. The other end of each lift arm 22 is pivotally attached at 24 to the grasper 12. For additionally rotating the grasper 12 while it is being inverted, thus providing a steeper dump angle, one end of each of a pair of actuator or follower arms 26 is pivotally mounted at 28 to the base plate 16 so the axis of rotation of the pivot mounts 28 is displaced from the axis of rotation of the actuator shaft 20. The other end of each follower arm 26 is pivotally mounted at 30 to the grasper 12, the axis of rotation of the pivot mounts 30 being displaced from the axis of rotation of the pivot mounts 24. As illustrated, both the lift arms 22 and the follower arms 26 are generally straight and have no bends or curves, with the follower arms 26 being mounted to the base plate 16 outboard of the ends of the actuator shaft 20. A similar lifter, but without the grasper of the present invention, may been seen as U.S. Pat. No. 6,503,045, which was incorporated by reference above.

In keeping with the present invention, a unique grasper assembly 12 is provided that is capable of gripping a variety of styles of residential-type refuse receptacles and which, when stowed, has a low profile. One advantage of a low profile is that it does not impede the use of other dumping accessories that may be incorporated into the refuse collection truck.

As illustrated, grasper assembly 12 comprises a generally planar face plate 32 that has a pair of generally horizontally-orientated, spaced-apart frame numbers 34 secured to the back side thereof by, e.g., welding. To one of the pair of ends of frame members 34, a gripper arm generally designated 36 is pivotally mounted at 38. The gripper arm 36 defines an arm-receiving region for generally receiving an opposed gripper arm 40. In the illustrated embodiment, gripper arm 36 has a pair of parallel spaced-apart arms 36a and 36b, with the space between them defining the arm receiving region. Alternatively, for example, arm 36 could be a single solid arm with an elongated recess or slot therein defining the arm receiving region. The rigid gripper arm 40 is pivotally mounted at 42.

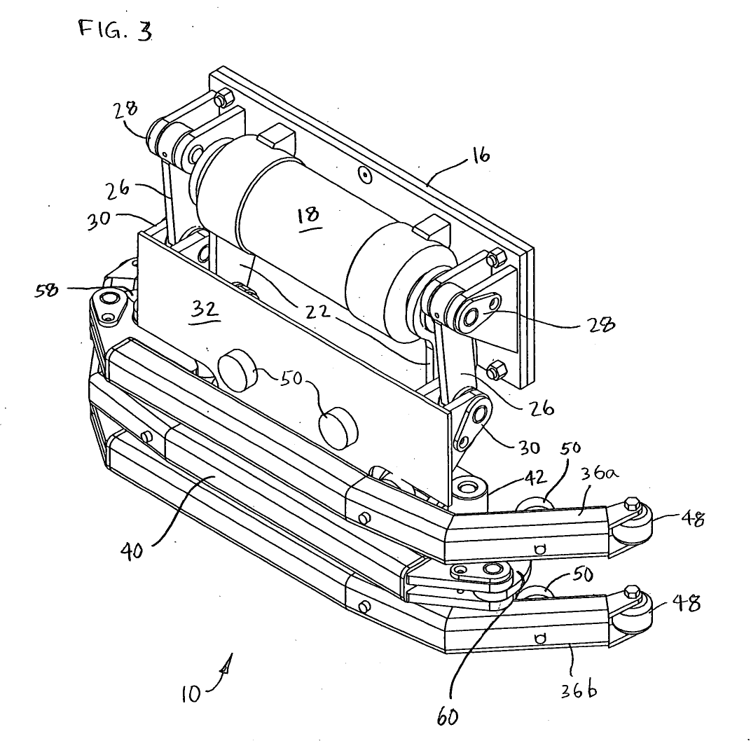

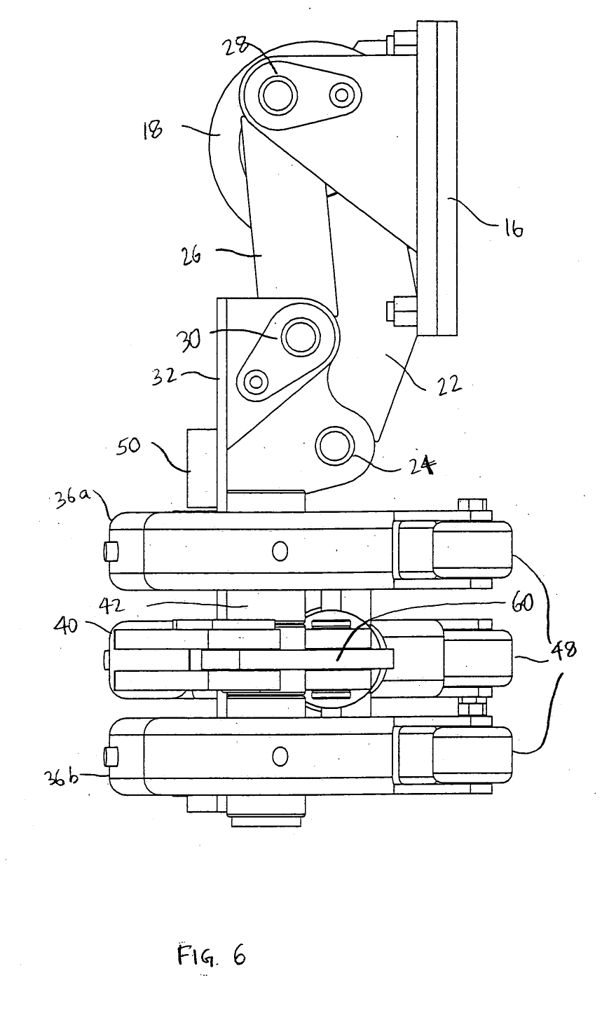

The rigid gripper arm 40 is pivotally mounted at 42 to the other pair of the ends of the frame members 34. Each gripper arm 36a, 36b and 40 has a generally straight portion 44, which lays generally flat along the face plate 32 when the gripper arms are in their stowed position (as best seen in FIGS. 3 and 6). Additionally, the single gripper arm 40 is positioned so that it nests in the arm-receiving space between the pair of gripper arms 36a, 36b when stowed. As a further alternative, a pair of opposed gripper arms could be substituted for the three gripper arms shown, with one of the gripper arms 36a or 36b being eliminated. Thus, in the stowed position, the gripper arms would lay side-by-side against the face plate.

The outer portion of each gripper arm 36a, 36b and 40 forms an angle with respect to straight portion 44. The outer portion 46 helps the gripper arms to more closely conform to the more typical shape of the receptacles to be lifted. Further, because the outer portion 44 lies beyond the boundary of the face plate 32 when in the stowed position, they do not prevent the straight portion 44 from laying closely against the face plate 32 (FIG. 6), thus ensuring a low profile for the lifter when in the stowed position.

The ends of each gripper arm 36a, 36b and 40 includes a roller 48 to help move the receptacle to be gripped in toward the face plate 32 as the gripper arms close. The gripper arms 36a, 36b, 40 and the face plate 32 also include raised resilient bumpers 50 that assist in securely gripping the refuse receptacle.

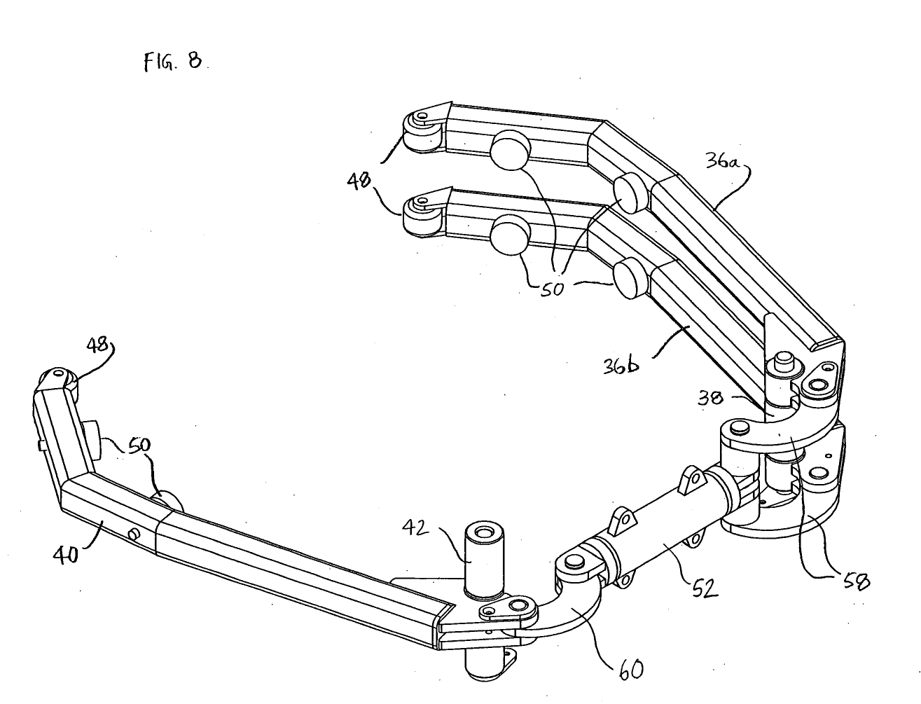

For moving the gripper arms 36a, 36b and 40 between the open position for receiving a refuse receptacle (FIGS. 2 and 8) and a closed position for stowing the gripper arms (FIGS. 3, 4, 6 and 7), an actuator 52 (preferably but not necessarily hydraulic) is provided. The actuator 52 has a opposed rods 54, 56 that are pivotally attached to the pair of gripper arms 36a, 36b and the single gripper arm 40 by links 58, 60 respectively. As is readily appreciated, the rods 54, 56 extend and retract in unison to move the gripper arms between the receptacle receiving and stowed positions.

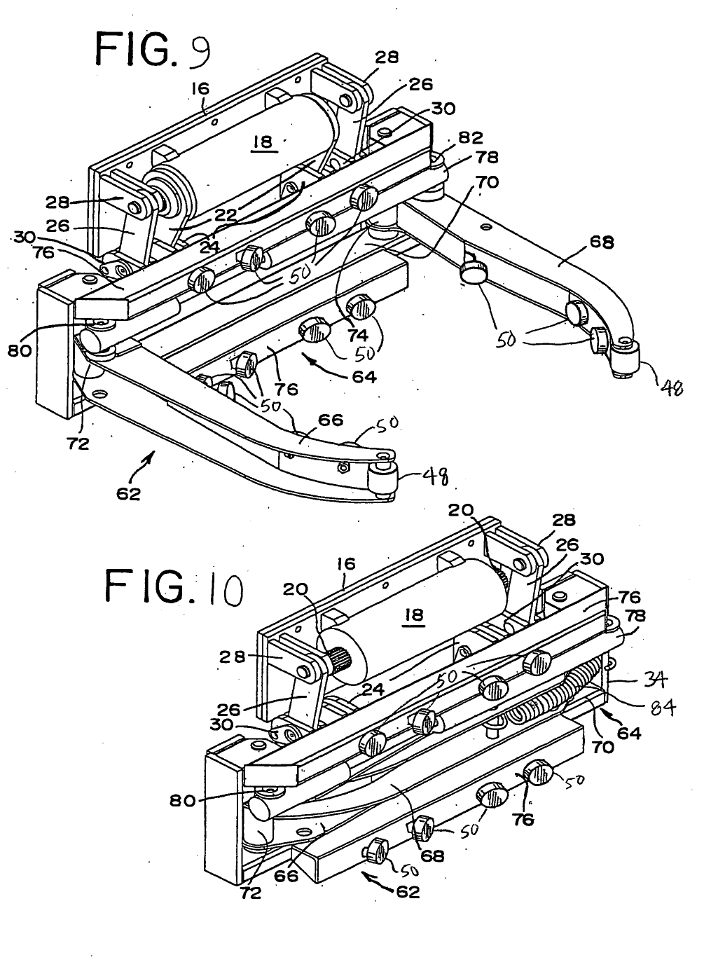

Turning to FIGS. 9-11, there is seen a second embodiment of receptacle lifter assembly, generally designated 62, in accordance with the present invention. As illustrated, the lifter assembly 62 utilizes a lifter mechanism 14 substantially the same as that described above. Consequently, there is no further description of this lifter mechanism, and identical reference numerals are used in the drawings for indicating the elements corresponding to those previously described.

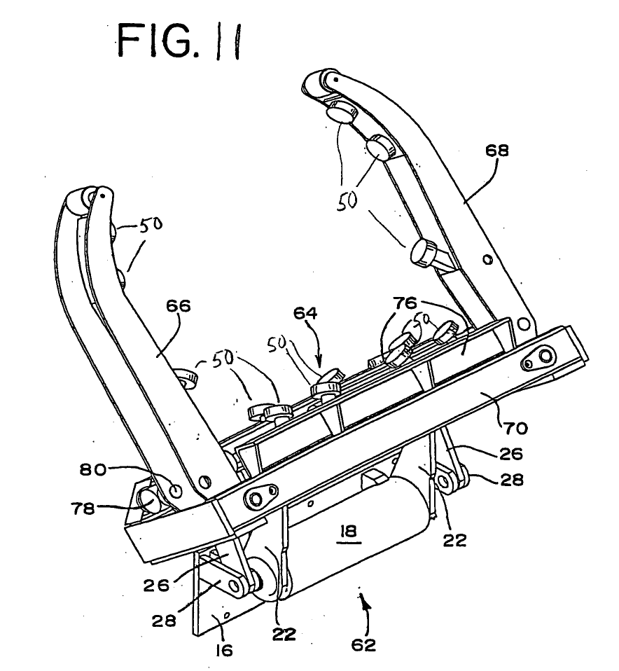

The lifter assembly 62 includes a grasper mechanism 64 comprising opposed rigid gripper arms 66, 68 that are secured to a multi-part, generally U-shaped support frame 70 by pivot mounts 72, 74. Instead of a face plate, the carriage 64 includes two spaced-apart rails or bumpers 76 secured to the support frame 70. The bumpers 76 are sized in width to project outwardly from the support frame a distance generally equal to the outward-most extent of the gripper arms 66, 68 when they are in the stowed position (FIG. 10). As such, the bumpers 76 also serve to protect the gripper arms 66, 68 when they are in the stowed position, as well as to provide a surface against which a refuse receptacle is held.

In keeping with the invention, the gripper arms 66, 68 are sized and configured so that one of the gripper arms nests at least partially in the other gripper arm when in the stowed position. This helps to insure that the lifter assembly obtains a low profile when the gripper arms are stowed.

To this end, gripper arm 66 has a generally U-shaped cross-section defining an arm-receiving recess or slot, with the open side of arm being on the outer side of the gripper arm and opening outwardly when in the stowed position. Gripper arm 68 has a cross-sectional shape and size that permits its to fit within the opening or recess in the gripper arm 66 when in the stowed position.

In order to move the gripper arms 66, 68 between the stowed (FIG. 10) and the receptacle receiving position (FIG. 9), an actuator mechanism 78 is provided. The actuator mechanism 78, as illustrated, comprises a double-acting hydraulic cylinder secured on each end to one of the gripper arms 66, 68 by pivot mounts 80, 82.

Because grabber arm 68 nests within grabber arm 66, the grabber arms must move to the stowed position in the proper sequence, with grabber arm 66 preceding grabber arm 68. This may be accomplished by different means. For example, the controls for the actuator 78 may include sequence valving so that gripper arm 66 advances to the stowed position before or ahead of the gripper arm. In the illustrated embodiment, the cost of the sequence valving is avoided by interposing a coil spring 84 between the gripper arm 68 and frame member 34 (FIG. 10). The spring 84 provides sufficient extra resistance to closing of the grabber arm 68 to ensure that grabber arm 66 advances to the stowed position ahead of the grabber arm 68. Other resilient members can be substituted for the coil spring 84, as would be apparent to one of ordinary skill in the art.

Thus, an improved low-profile refuse receptacle lifter has been provided. While the invention has been described in the context of certain preferred embodiments, other variations will be apparent to those skilled in the art. Consequently, There is no intent to limit the invention to the disclosed embodiments. Instead, the scope of the invention is defined by the following claims.

1. A grasper adapted to the mounted to a lifter for inverting and dumping a refuse receptacle, the grasper comprising:
a support carried by the lifter;
a first gripper arm pivotally carried by the support;
a second gripper arm pivotally carried by the support, the first and second gripper arms being pivotable between a first position in which the first gripper arm is spaced apart from the second gripper arm for receiving the refuse receptacle therebetween and second position in which the first and second gripper arms lay generally flat against the support for storage; and
an actuator secured to the support for moving the gripper arms between the first and second positions.

2. The grasper of claim 1 wherein the second gripper arm nests in the first gripper arm when the gripper arms are in the second position.

3. The grasper of claim 2 wherein the first gripper arm defines an opening sized to receive the second gripper arm when the gripper arms are in the second position.

4. A grasper adapted to the mounted to a lifter for inverting and dumping a refuse receptacle, the grasper comprising:
a support carried by the lifter;
a first gripper arm pivotally carried by the support, the first gripper arm defining an elongated arm-receiving region;
a second gripper arm pivotally carried by the support, the first and second gripper arms being moveable between a first position in which the first and second gripper arms are spaced apart for receiving a refuse receptacle therebetween and second position in which the first and second gripper arms are positioned generally adjacent the support, with the second gripper arm located in the arm-receiving region of the first arm; and
an actuator carried by the support for moving the gripper arms between the first and second positions.

5. The grasper of claim 4 wherein the first gripper arm comprises a pair of members defining a space therebetween and the second gripper arm nests in the space defined by the first gripper arm when the gripper arms are in the second position.

6. The grasper of claim 4 wherein each gripper arm defines a fixed end secured to its respective pivot and a free end opposed to the fixed end, the gripper arms being sized in length so that the ends extend beyond the support when in the second position.

7. The grasper of claim 6 wherein each gripper arm has a generally linear portion extending from the fixed end that lays generally flat against the support in the second position and an angled portion at the free end that lays behind the plain defined by the support when in the second position.

8. The grasper of claim 4 wherein the actuator comprises a hydraulic cylinder.

9. A carriage adapted to the mounted to a lifter for inverting and dumping a refuse receptacle, the carriage comprising:
a frame structure pivotally mounted to the lifter;
first gripper arm moveably mounted to the frame structure by a first pivot, the first and second gripper arms being generally in alignment and in spaced relation and adapted to move in unison about the first pivot;
a third rigid gripper arm moveably mounted to the frame structure by a second pivot or movement about the second pivot, the first, second and third gripper arms being moveable between a first position in which the first and second gripper arms are spaced apart from the third gripper arm for receiving the refuse receptacle and second position in which the first, second, and third gripper arms lay generally flat against the frame structure for storage; and
an actuator secured to the frame structure for moving the gripper arms between the first and second positions.

10. The carriage of claim 9 wherein the third gripper arm nests in the space between the first and second gripper arms when the gripper arms are in the second position.

11. The carriage of claim 9 wherein each gripper arm defines a fixed end secured to its respective pivot and a free end opposed to the fixed end, the gripper arms being sized in length so that the ends extend beyond the frame structure when in the second position.

12. The carriage of claim 11 wherein each gripper arm has a generally linear portion extending from the fixed end that lays generally flat against the frame structure in the second position and an angled portion at the free end that lays behind the plain defined by the face plate when in the second position.

13. The carriage of claim 9 wherein the actuator comprises a hydraulic cylinder.
